(19) United States
(12) Patent Application Publication
(10) Pub. No.: US 2007/0052594 A1
(43) Pub. Date: Mar. 8, 2007

(54) Radio-operated communication sender

(75) Inventor: Peter Nevermann, Langenfeld (DE)

Correspondence Address: THE FIRM OF KARL F ROSS, 5676 RIVERDALE AVENUE, PO BOX 900, RIVERDALE (BRONX), NY, 10471-0900, US

(73) Assignee: LUMBERG CONNECT GMBH & CO. KG

(21) Appl. No.: 11/514,280

(22) Filed: Aug. 30, 2006

(30) Foreign Application Priority Data
Sep. 3, 2005 (DE) 102005041890.2

(51) Int. Cl. H01Q 1/38

(52) U.S. Cl. 343/700 MS; 343/895

(57) ABSTRACT

This document represents and describes an antenna for a wireless communication terminal with at least one essentially planar radiating element, wherein at least one section of the radiating element is folded in a waving to meandering fashion. According to the invention, the folded section of the radiating element is three-dimensionally double-folded by folding lengthwise in at least two directions arranged at an angle (W) in relation to each other (R1; R2). Such a three-dimensional antenna structure creates an antenna which, while maintaining the external dimensions of a typical planar radiating element, has a significantly lower space requirement. The antenna according to the invention is therefore especially suitable for installation in highly miniaturized devices such as mobile phones.

The invention relates to an antenna for a wireless communication terminal with at least one basically planar radiating element, wherein at least one section of the radiating element is folded in a waving to meandering pattern, according to the characteristics of the preamble in claim 1.

The ever increasing demands on the functionality of wireless communication terminals, particularly mobile phones, requiring the integration of additional features such as cameras, loudspeakers, larger displays or numerous buttons, continue to reduce the available space for other essential components such as integrated antennas. There is an existing long-time serious demand for (further) miniaturizing of antennas. Also, the number of frequency bands supported by mobile transmission equipment is growing. Antennas which can be operated with additional bands (so-called multi-band devices) have increased space requirements for technical reasons, since it requires additional elements, such as additional parasitic radiating elements.

Cars and other vehicles, as well as ships and aircrafts, also require antennas with preferably small external dimensions. For example, such a small overall size is desirable to avoid wind noise, minimize air resistance or because it eliminates the necessity to remove the antenna when getting your car washed.

A widespread antenna structure, especially in mobile radio transmission, is the Planar Inverted F Antenna (PIFA). The side length dimensions of the planar radiating element basically depend on the frequency (wavelength) at which the antennas are to be operated. A basic PIFA has a relatively high space requirement.

A popular solution to reduce the space requirement of an antenna has been described in EP 1 286 417 A2 and involves metal layers being arranged partially over each other. With the above-mentioned patch antenna, however, this will involve only marginal areas of the radiating element, resulting in planar radiating terminal areas being arranged in parallel over each other.

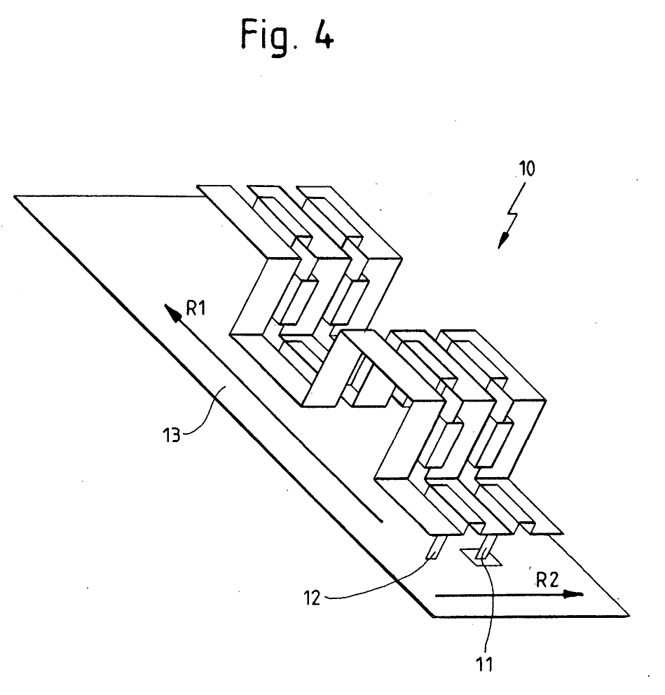

EP 1 026 774 A2 shows that Planar Inverted F Antennas can be shortened if the radiating element is provided in a waving design, as shown in FIG. 6 therein, or in a square meandering design, as illustrated by FIG. 8.

On this basis, it is the task of the present invention to provide a novel antenna with a radiating element that is designed so skillfully that it facilitates further miniaturizing of the antenna.

The invention solves this task using the characteristics set forth in claim 1 and is characterized in that the folded section of the radiating element is double-folded three-dimensionally by folding lengthwise in at least two directions arranged at an angle in relation to each other.

The core principle of the invention, therefore, is this: while maintaining the basic structure and the external dimensions of a planar radiating element, miniaturizing can be achieved by folding as large an area as possible, preferably the entire radiator, in such a way that partial areas of the radiator are no longer on the same level, thus significantly reducing the spatial requirements of the antenna.

The basic difference in relation to the antenna described in EP 1 286 417 A2 is that with the radiating element according to the invention, the differently designed areas lie beside each other, not over each other, and between the radiating element and the base.

The antenna according to the invention differs significantly from the antenna according to EP 1 026 774 A2 in that it is structured not in a single direction but in two directions arranged at an angle W to each other. Only this design utilizes the possibility to further miniaturize a planar radiator significantly.

Especially to facilitate cheap production of the radiating element for the antenna according to the invention, the invention also specifies that the folds of the radiating element are defined by folding lines, which are interrupted by spaced material attenuation zones preferably formed by gaps in the radiating element.

Regarding the electrical properties of the antenna, it is desirable and advantageous for the gaps to be small enough in proportion to the total area that they cannot significantly influence the electrical behavior of the radiating element.

The material attenuation zones or gaps should preferably be located at the crossing points of the folding lines enclosed by the angle (W). In principle, the angle (W) may vary between 0° and 180°, but it is recommended that the angle (W) be a right angle of 90° also in view of the foldability of the planar radiator, which is beneficial in product engineering.

Regarding the practical construction design, the antenna is distinguished by a zigzag-like folding of the radiating element in a first direction. The radiating element can also be folded in a zigzagging fashion in the second direction, resulting in an antenna with a radiating element that is double-folded in a zigzagging fashion in two angled directions.

A similar structure can be obtained by providing a double folding in a meandering fashion in these two directions instead of a zigzagging folding in two directions.

Another design according to claims 12 and 13 involves an antenna in which the radiating element is formed in a zigzagging fashion in one direction and in a three-dimensional meandering fashion in the other direction.

The folding can have a continuous grid pattern, with all folding lines being spaced evenly. In addition, it is intended in one embodiment of the invention for the folding to be in a continuous grid pattern in which the zigzagging folding lines alternate with straight sections.

If an antenna is designed with a mass area, which is usually the case, one of the two directions can be parallel to the surface of a mass area. In another preferred arrangement of the radiator and the mass area, one of the two directions is vertical to the surface of the mass area. The former results in an extremely flat antenna, the latter in a slender, vertical antenna.

The invention is best understood with reference to the following descriptions of embodiment examples shown in the illustrations. These illustrations show:

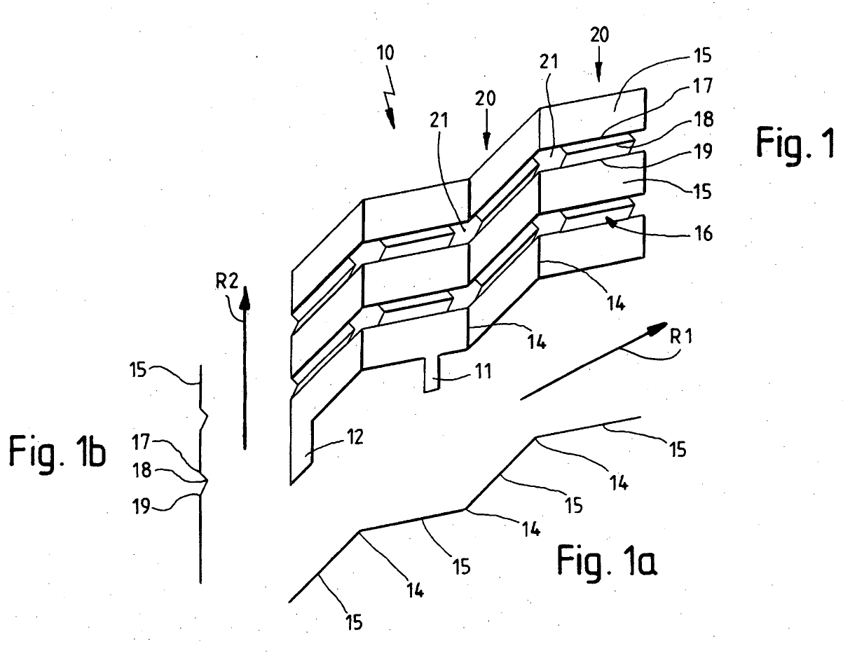

FIG. 1 a graphic, schematic view of a radiating element folded in a zigzagging fashion in two directions,

FIG. 1a a schematic, linear representation of the folding in a first direction,

FIG. 1b a schematic, linear representation of the folding in the second direction,

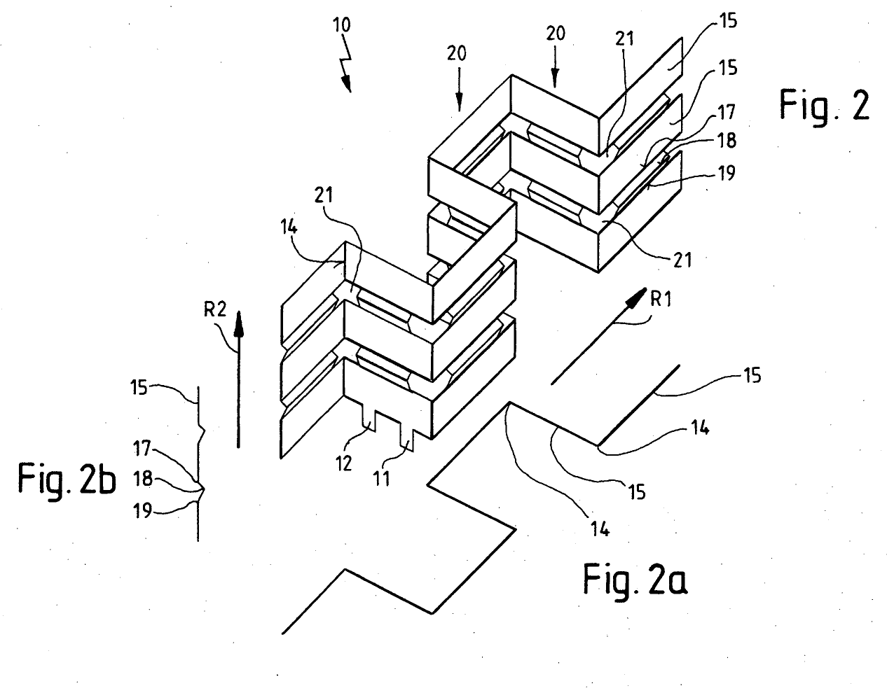

FIG. 2 a graphic, schematic view of a radiating element folded in a meandering fashion in a first direction and in a zigzagging fashion in a second direction,

FIG. 2a the meandering course in the first direction,

FIG. 2b the zigzagging folding course in the second direction,

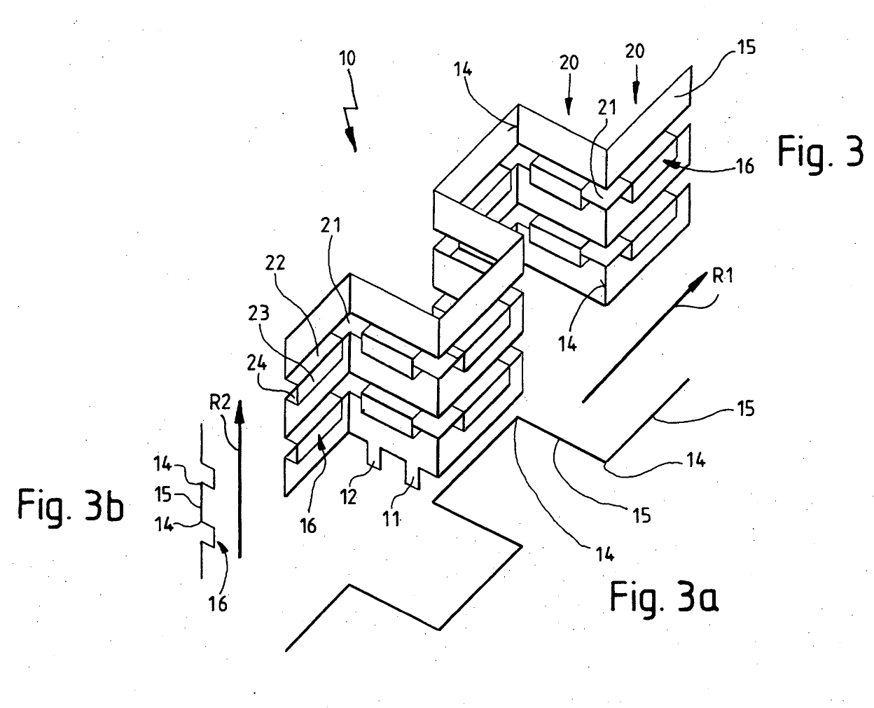

FIG. 3 a graphic view of a radiating element designed in a meandering double-fold in two directions,

FIG. 3a the folding course in a first direction,

FIG. 3b a potential folding course in the second direction, and

FIG. 4 a graphic representation of an embodiment where the orientation is modified from FIG. 3 in relation to a mass area.

A radiating element generally referred to as 10 basically consists of a planar, flat cross-section metal strip. A so-called point of delivery 11 and a base contact 12 are attached thereto to connect to the base 13, which represents a mass area and is shown only in FIG. 4.

In the embodiment shown in FIG. 1, the radiating element 10 is folded in a zigzagging fashion in relation to a first direction R1. These folds are defined by folding lines 14, which alternate with planar, straight sections 15. The folding lines 14 run a vertical course to the direction R1 defined in FIG. 1. This is direction R2, which runs perpendicular to the direction R1 in the illustrated embodiment.

The radiating element 10 is also folded lengthwise to this second direction R2, in peak-type intervals, forming a zigzagging folding pattern. As a result, a peak-like folding 16 is intended between two neighboring planar sections 15 in the R2 direction. Three folding lines 17, 18 and 19 are responsible for this. All these folding lines 17, 18 and 19 run parallel to each other within each individual zigzagging section 20 of the folding described initially, which might also be referred to as “basic folding.”

As can clearly be seen from FIG. 1, the respective extensions of the folding lines 14, 17, 18 and 19 are interrupted by areas which are designed as gaps 21 in the radiating element 10 of the embodiment example. These gaps 21 effectively form the crossing points of a grid. Instead of the gaps 21, one might also consider providing clear material attenuation zones at these points, which would allow for the double folds in the crossing points intended by the invention. Gaps 21 are easier to produce; however, one should ensure that the gaps 21 are as small as possible to avoid influencing the electrical behavior of the radiating element 10 in an undesired direction.

While FIG. 1, clarified by FIGS. 1a and 1b, shows a three-dimensional radiating element 10 double-folded in a zigzagging fashion, FIG. 2 exemplifies an embodiment in which direction R2 basically has the same structure, while the folds in direction R1 are not designed in a zigzagging fashion, as in the first embodiment example, but in a meandering fashion. Consequently, alternating planar elements 15, viewed in the R1 direction, enclose a smaller interior angle (preferably 90. In the embodiment example of the zigzagging folding shown in FIG. 1, this angle is wider. It can be seen that the length of the radiating element in FIG. 2, measured in the R1 direction, is significantly shorter compared to the first embodiment, due to the folding, if this is based on an identical initial length of a planar radiating element.

Another modification in the context of the invention is shown in FIG. 3, with additional explanation provided by FIGS. 3a and 3b. Again, there is a three-dimensionally double-folded radiator 10. Its configuration in the R1 direction is identical to that in the embodiment example shown by FIG. 2, i.e., meandering. However, the configuration in the R2 direction is also in a meandering design. Compared to the embodiments described above, the peak formations 16 now are no longer angled acutely but defined by three areas. These areas 22, 23 and 24 do not have to be arranged perpendicular to each other. Other folding cross-sections are possible, e.g., unsymmetrical meanders, wave-shaped, distorted or even multi-cornered folds.

The radiator 10 of the embodiment example shown in FIG. 4 is the same as that shown in FIG. 3. This is merely a different arrangement, in which the radiator essentially runs parallel to the mass area 13, while it is placed vertically upon it in the embodiment example of FIG. 3.

1. An antenna for a wireless communication terminal with at least one essentially planar radiating element, wherein at least one section of the radiating element is folded in a waving or meandering fashion and wherein the folded section of the radiating element is three-dimensionally double-folded by folding lengthwise in at least two directions arranged at an angle in relation to each other.

2. An antenna according to claim 1, wherein folding lines define the folds of the radiator element and the folding lines are interrupted at intervals by material attenuation zones.

3. An antenna according to claim 2, wherein the material attenuation zones are formed by gaps in the radiating element.

4. An antenna according to claim 3, wherein the gaps are small enough in relation to the total area of the radiating element not to significantly influence the electrical behavior of the radiating element.

5. An antenna according to claim 1 wherein the material attenuation zones or gaps are designed to be at the crossing points of the folding lines enclosed by the angle.

6. An antenna according to claim 1 wherein the angle is a right angle.

7. An antenna according to claim 1, characterized by a zigzagging folding of the radiating element in a first direction.

8. An antenna according to claim 1, characterized by a zigzagging folding of the radiating element in a second direction.

9. An antenna according to claim 7, characterized by a zigzagging folding of the radiating element in a second direction.

10. An antenna according to claim 1, characterized by a meandering folding of the radiating element in a first direction.

11. An antenna according to claim 1, characterized by a meandering folding of the radiating element in a second direction.

12. An antenna according to claim 10, characterized by a meandering folding of the radiating element in a second direction.

13. An antenna according to claim 7, characterized by a meandering folding of the radiating element in a second direction.

14. An antenna according to claim 8, characterized by a meandering folding of the radiating element in a first direction.

15. An antenna according to claim 1 wherein the folding occurs in a continuous grid pattern and all folding lines are spaced evenly.

16. A radiating element according to claim 1 wherein folding occurs in a continuous grid pattern and the folding lines forming a zigzag pattern alternate with flat sections running in the first direction.

17. An antenna according to claim 1 wherein one of the two directions is parallel to the surface of a mass area.

18. An antenna according to claim 1 wherein one of the two directions is vertical to the surface of a mass area.
